(19) United States
(12) Patent Application Publication
(10) Pub. No.: US 2013/0208846 A1
(43) Pub. Date: Aug. 15, 2013

(54) Liquid nitrogen emergency cooling system for nuclear plants

(71) Applicant: Scott Clair Pockrandt, Ridgecrest, CA (US)

(72) Inventor: Scott Clair Pockrandt, Ridgecrest, CA (US)

(21) Appl. No.: 13/694,431

(22) Filed: Dec. 3, 2012

Related U.S. Application Data
(60) Provisional application No. 61/630,321, filed on Dec. 9, 2011.

(51) Int. Cl. G21C 15/18

(52) U.S. Cl. CPC G21C 15/18
USPC 376/282

(57) ABSTRACT

The Liquid Nitrogen Cooling System utilizes a continuously recharged, closed-loop system to: generate electricity; charge and pressurize hydraulic bypass and operational equipment; and, provide emergency cooling.

It is triggered by any need for emergency shutdown, applying liquid Nitrogen to cool a nuclear power plant, as an alternate cooling system independently from the regular cooling system, providing a sudden drop of temperature through a liquid Nitrogen manifold system.

No greenhouse or explosive gases are generated or released, and no Oxygen is used. Any Nitrogen vented to the atmosphere dissipates rapidly, assumes ambient temperature, and has no long half-life radioactive isotopes. It operates as a closed/static system until needed for cooling.

Applications include, but are not limited to, retrofitting to existing systems.

### OVERVIEW OF SYSTEM

Current emergency cooling systems rely heavily on a mass storage of water, and a comparatively small temperature difference for cooling. My system provides for a differential of over a greater range from coolant to “boil off” temperatures, providing a more efficiency in cooling, while producing no explosive gasses (such as Hydrogen, etc.) which can be produced by current cooling systems.

Further, current systems are large scale and massive in size, and rely on generated power, gravity feed and/or pressurized systems and manual activation of several components to secure the shutdown of a nuclear plant in the event of natural disaster, damage or attack, etc. My system is activated automatically, and passively, to immediately by means of the application of liquid Nitrogen to cool overheated equipment to a safe working temperature. This eliminates the production of Hydrogen or other hazardous gases caused by the overheating of equipment, and the subsequent danger of explosion.

The application of this process and method, is not a “common usage” or “obvious” use of the materials involved. There is no other system which takes advantage of the materials a processes as set forth in my system. The components listed in this application constitute the full system as designed for use in an existing or newly constructed generation facility, are set forth as an example of the use of the process and method, and are not exhaustive or all inclusive.

### Basic Operating Parameters

In its current form, the process and method will utilize current “waste energy”¹ and/or engineered energy, produced by an electrical generation plant to continuously collect, condense, cool, store and recycle Nitrogen gas (hereinafter N2) from the atmosphere for use in the system. 1 The waste energy is that energy which is normally produced as a stand-by amount, and which must be continually produced “in case” a demand is placed on the power grid. This is an unavoidable energy, which represents drag, and therefore loss, on the generation system, without being used for practical purposes.

The N2 is extracted from the atmosphere by a separation system, which is already widely available. The N2 is compressed to pressure, and cooled to liquid, and then stored in liquid form for use in the system which is passively activated. Part of the N2 is continuously cycled to produce electricity for on-site usage, and to recharge an electrical storage unit. This N2 is recovered in a closed system.

Once activated, the liquid N2 that is stored is applied to cool overheated equipment, and is recovered in an “operating pressure”² safety system, which is more efficient than current systems which merely exhaust the containment heat by water cooling through heat exchange. 2 Operating pressure, is a low pressure system used to recycle the N2 back to the liquefaction unit to be reused in the system.

N2 is a natural component of the atmosphere, comprising approximately 80% of the air we breath, non-reactive and is non-explosive. The N2 will, upon expansion be held in a closed low, medium or high pressure system. Even if that closed system were to be breached, the N2 would be released at atmospheric pressure with no pollution generated.

Finally, N2 is safe to use in the system, and even if exposed to nuclear material, it has no long-lasting residual effects, and does not pose any significant danger to people, soil, air, animals or plants. There are no long-lasing radioactive isotopes which would result in contamination or pose health risks.³ 3 Natural Nitrogen (N) consists of two stable isotopes, ¹⁴N, which makes up the vast majority of naturally occurring nitrogen, and ¹⁵N. Fourteen radioactive isotopes have also been identified, with atomic masses ranging from ¹⁰N to ²⁵N, and 1 nuclear isomer, ^{11m}N. All are short-lived, the longest-lived being ¹³N with a half-life of 9.965 minutes. All others have half-lives under 7.15 seconds, with most under five-eighths of a second. Most of the isotopes with mass below 14 decay to isotopes of carbon, while most of the isotopes with mass above 15 decay to isotopes of oxygen. The shortest-lived isotope is ¹⁰N, with a half-life of 2.3 MeV. (Source available.)

This system is efficient, affordable and readily available to retrofit to existing nuclear power generation plants, and can be incorporated into new facilities.

My original intellectual contributions are the configurations processes and methods that are needed to accomplish the automatic operation and safe application of liquid N2 coolant, extraction and storage of liquid N2 for use as coolant, and the recapture system for the N2, and the reduction of radiation danger potential, as well as the drawings.

The components listed in the drawing page are necessary to, and comprise the unique elements of, the complete system.

This filing refers to Provisional Patent No. 61630321,filed by Scott Clair Pockrandt, and issued on Dec. 9, 2011.

### Additional Applications

In addition to large-scale nuclear generation units, we intend to develop the following applications for other systems:

Small-scale applications for nuclear generation units.

Further research will be conducted to determine how the system can best be

adapted for use in small-scale nuclear generators.

Small-scale application for portable nuclear generation units.

Further research will be conducted to determine how the system can best be

adapted for use in small-scale nuclear generators on board aircraft, shipping,

spacecraft, rural and residential applications.

Heavy and light manufacturing process power supply configurations.

Further research will be conducted to determine how the system can best be

adapted for use in small-scale, medium-scale and large-scale applications

suited for power-grid-independent nuclear generators, which can operate in as stand-alone configuration for such operations.

All of these configurations will achieve the basic goal of providing safety for emergency shut down and cooling of power generation plants.

1. I have developed a process and method which uses Nitrogen gas, in liquid and “operating-pressure” forms, to provide for the safe cooling and shutdown of a nuclear generation plant.

2. I have developed a process and method that produces no greenhouse gas emissions, uses no Oxygen and does not create an additional burden on the commercial power grid, or secondary sources of energy that depend on fossil fuels for operation, and which operates in a fail-safe manner to provide emergency cooling for the shutdown of a nuclear generation plant.
